(19) United States
(12) Patent Application Publication
(10) Pub. No.: US 2026/0243345 A1
(43) Pub. Date: Aug. 20, 2026

(54) JOINT COVER

(71) Applicant: GEFFERS PATENT GMBH, Gundelfingen (DE)

(72) Inventors: Heiko Geffers, Gundelfingen (DE); Sandra Geffers, Gundelfingen (DE)

(21) Appl. No.: 19/471,916

(22) PCT Filed: Apr. 26, 2023
(86) PCT No.: PCT/EP2023/060971

§ 371 Date: Oct. 2, 2025

(51) Int. Cl. F16J 15/02; A47K 3/00

(52) U.S. Cl. CPC F16J 15/02; A47K 3/001

(57) ABSTRACT

The invention relates to an elongated joint tape for use in sanitary applications. The joint tape comprises elastic material, is asymmetrically tapering and one side flank of the joint tape comprises an attachment means.

### CROSS-REFERENCE TO RELATED APPLICATION

This Application is a Section 371 National Stage Application of International Application No. PCT/EP2023/060971, filed Apr. 26, 2023 and published as WO 2024/223039 A1 on Oct. 31, 2024, in English.

### BACKGROUND

The present invention relates to a joint cover for use in sanitary applications. More specifically the present invention relates to a joint tape for covering joints at sanitary objects.

In wet rooms, especially sanitary rooms, it is common practice to close all joints between floors, walls and thereto installed objects. This is done firstly to achieve a visual finish, secondly to prevent dirt and liquid from entering and collecting in the joints, thirdly to simplify cleaning and finally to protect the walls themselves. Without a joint cover, mildew would likely occur and sensitive wall materials would quickly wear out due to usual cleaning in the corners and around sanitary objects.

Thus, in sanitary rooms, joints between sanitary objects such as washbasins, washstands, WCs, bidets, urinals, bathtubs or shower trays and the tiled, plastered or wallpapered walls have always been provided with silicone seams to close the gap between the sanitary object and the wall.

Creating silicone seams is time-consuming and therefore costly. First, more silicone as actually needed is applied along the joint using a silicone syringe with a tube of silicone clamped into it. In a next step, the silicone is smoothed out with special jointing tools and excess material is removed. Any accurate finishing work required on the silicone seam is then done using a finger dipped in a bowl of water and detergent mixture. Finally, the silicone seam must dry for 12 to 24 hours. Until the silicon seam is fully dried it must not get wet, must not be touched and must not get stressed. So, sanitary objects which are freshly siliconized cannot be used during this drying period. The excess silicone from the installation process is discarded. Frequently, there is also a left over in the silicone tube which is discarded since it can no longer be used if there is not enough residual material for the next joint length.

The described work of siliconizing requires a clean and conscientious execution, so a skilled worker with appropriate expertise and several tools is needed. Still, the appearance of the silicone seam strongly depends on the dexterity of the worker. Additionally, depending on the shape of the object, it varies in difficulty to always draw a neat joint of the same thickness and this is why often each joint looks slightly different.

Despite their complex and cost-intensive installation, durability of conventional silicone seams is limited due to several reasons. First, silicone joints crack with time due to aging of the material and due to work of the building elements against each other. Secondly, there may be repair work on a sanitary object for which it is necessary to dismantle it and therefore break up the silicon seam. Anyway, the silicone seam has to be renewed just as elaborately, whereby the clean removal of a worn silicone seam often leads to further effort. So, replacement often results in even greater costs and effort than initial installation. Moreover, the removed silicone seams are broken and not reusable, so they need to be discarded.

All in all, conventional silicone seams are time-consuming and costly in installation and renewal, have limited service life and lack sustainability. Nevertheless, using conventional silicone seams in sanitary rooms is still common practice although other sealing methods are known which overcome at least some disadvantages of the above described silicon seams.

Disclosed in DE 10 2017 110 057 A1 is a tear-resistant joint cord for use in sanitary rooms. Further disclosed is a process to seal a joint between two walls or objects using the presented joint cord in combination with a sealing material. According to the presented process a joint cord is positioned fully inside the joint and the joint is covered with a sealing material, e.g. silicone which adheres to the joint cord. Thus, the complete joint sealing including the sealing material can easily be removed by cutting the sealing material from the walls and pulling the joint cord out of the joint. So, removal of the silicone seam is simplified. Nevertheless, producing a neat silicone seam still requires almost as much effort and knowledge as described above, durability is only slightly increased and the joint cord is not reusable.

DE 20 2020 100 594 U1 discloses a joint sealant for sealing and covering joints between surfaces arranged at an angle to each other. This joint sealant has a visible side and an opposite contact side and comprises a base body. The base body has on its contact side at least one fastening pin which extends away from the contact side and is formed at least in regions from a material which is softer or more flexible than the material from which the base body is formed. Further, the base body has on one side in each case sealing ends which are formed from a material which is softer or more flexible than the material of the base body. The joint sealant is designed to be pushed into a joint so that the fastening pin keeps the sealant in its position and the sealing ends cling to walls or objects which are in angular position. To secure the sealant in its position, the fastening pin is barbed and it is suggested to stick the joint sealant into the joint by using any kind of adhesive or silicone. Either way, it is not possible to easily remove this joint sealant if necessary and reusability is not given. Moreover, the joint sealant is complex in its material structure since different properties are required in different zones. The base body's properties are stiff compared to the other elements of the joint sealant, so to provide a good design for use along tiled walls, floors or shower trays. Nevertheless, for installation in small joints, in tight radii or around angles, the base body lacks flexibility and the fastening pin lacks retention force. Hence, the presented joint sealant cannot be used to seal joints around a majority of known sanitary objects.

EP 3 097 328 A1 also discloses elongate seaming devices for sealing a joint between two perpendicular surfaces. In one embodiment, the device includes an elongate body, an adhesive strip and a pair of wedge-shaped lips. The body has two perpendicular mounting sides and a visible side having a concave centre. However, due to the perpendicular arrangement of the mounting sides it is not possible to install the seaming device on a convexly shaped surface or in joints with different angles of the adjacent surfaces. Furthermore, while the seaming device in this embodiment may be suitable for sealing a joint between e.g. a bath tub and a wall, however, it is not possible to install the known seaming device around radii, e.g. of a sanitary object, or in corners. If an installation around radii is required, e.g. around a urinal, EP 3 097 328 A1 discloses another embodiment of a seaming device, wherein the seaming device is equipped with at least one barbed fastening pin.

Thus, there is a need to replace well-known silicone seams around sanitary objects, by means that overcome at least some of the above described disadvantages.

### SUMMARY

Disclosed embodiments of the present invention provide a joint sealing for joints at or around sanitary objects which improve the state of the art at least in terms of installation effort and/or sustainability.

Disclosed embodiments provide an elongated joint tape for covering a joint, the joint tape having a main body extending in a longitudinal direction and being enclosed by one convexly shaped main side, one concavely shaped right side flank and one concavely shaped left side flank, wherein the joint tape comprises elastic material, wherein the joint tape is asymmetrically tapering along the side flanks in a direction perpendicular to the longitudinal direction, and wherein one of the side flanks comprises an attachment means. In other words, the attachment means is provided to one of the side flanks. It can be said that one of the side flanks is equipped with the attachment means.

Preferably, the well-known definitions of concave and convex shapes relate to the joint tape's cross section perpendicular to the longitudinal direction or an axis extending into the longitudinal direction. It is pointed out that in cross section, a concave or convex contour may comprise several edges from partial surfaces building corners. The contour therefore may not be differentiable in every point but still fulfils the criterion of being concave or convex.

In this context, elastic material, preferably, is defined as any material which shows elasticity wherein elasticity is the property of a material to change its shape when a force is applied and to return to its original shape when the applied force is removed. Preferably, elastic material in this context shows the described behavior under standard conditions while a minimum engineering strain of 10% can be achieved during applying stress smaller than 30 MPa. So, it preferably is beneficial to be used in applications as described in the following.

The elongated joint tape of the present invention is designed to cover a joint. Preferably, the elongated joint tape is designed to cover a joint passing along or preferably around a sanitary object. Such a sanitary object may preferably be a wall-mounted or standalone sanitary object such as a washbasin, WC, urinal or any object which is used in sanitary rooms. Alternatively, but in no way compulsorily, such a sanitary object may be connected to the floor and to one or more walls such as a bathtub or a shower tray. The gap between a sanitary object and the preferably plane surface, e.g. a wall or a floor, where the sanitary object is mounted to is called joint. The distance between the sanitary object and the named surface defines the joint's width. The joint may have a specific length associated with the sanitary object, preferably associated with a mounting section, e.g. a mounting edge or mounting edges, of the sanitary object. In the case of wall-mounted or standalone sanitary objects, the joint's length may be associated with the circumference of the sanitary object in its mounting section. In other words, in case of wall-mounted or standalone sanitary objects, the joint may comprise a circumference which is defined by being identical to the circumference of the sanitary object in its mounting section. The elongated joint tape may have a length that preferably is defined in a longitudinal direction of the joint tape. Preferably, the length of the elongated joint tape may be associated with the length of the joint.

Covering the described joint is necessary to finish the installation of the sanitary object. According to the present invention this is preferably done by attaching the elongated joint tape to the sanitary object by using the attachment means and guiding the joint tape at least partly into the joint. The inventive, asymmetrically tapering geometry of the joint tape ensures an ideal fit in the joint and causes parts of the side flanks to cling to adjacent surfaces after installation. So, the joint tape is at least partly in contact to the sanitary object's mounting section. In particular, the elongated joint tape comprising elastic material and having the asymmetrically tapering geometry preferably can smoothly be installed at joints having a small width and preferably can smoothly be fitted in or around radii of sanitary objects. Preferably, the elongated joint tape can be guided into corners between adjacent walls to smoothly cover a joint between two angled walls and a surface of a sanitary object. The angled walls preferably might have an angle greater than 30°, preferably greater than 60° and more preferably greater than 80°. Further, the angled walls preferably might have an angle smaller than 120°, more preferably smaller than 110° and particularly preferably smaller than 100°. Preferably, the installed joint tape is sealing the joint against environmental impacts such as dust, liquids or moisture. Among other things, the joint tape's main side preferably provides a visual finish to the joint and is easy to clean. Thus, the application of the elongated joint tape preferably provides a good sealing and optical finish to the joint. Installation of the joint tape is preferred to be performed without using any tools and without expert knowledge. More preferably, the elongated joint tape can also be removed without using any tools and without expert knowledge. As a result, the joint tape preferably is reusable in general, even if the attachment means might be renewed. In other words it is preferred that the joint tape's main body is reusable.

The main side of the elongated joint tape preferably remains visible once the joint tape is installed. More preferably, in installed condition, the main side is deformed, the left and right side flanks preferably are deformed as well and more preferably are at least partly in contact with the surfaces adjacent to the joint. Particularly preferably, at least a part of the joint tape is provided in the joint. In other words, the joint tape's convexly shaped main side preferably is designed to adopt a concave shape in installed condition. While the main side preferably is the visible side, left side and right side could also be exchanged depending on the orientation of the cross section, as will be apparent to the skilled person.

Preferably, the joint tape's left side flank adjoins the main side with a first inner angle of 15° to 50°, preferably 25° to 40° and/or the right side flank adjoins the main side with a second inner angle of 5° to 60°, preferably 20° to 40°. It is preferred, that the first and second angles differ from each other. Preferably, the described angles and further angles of the joint tape's symmetry which are related to in the description, are taken from the cross section of the joint tape. Preferably, this cross section is invariable over the entire length of the joint tape. Angle specifications at curved edges are preferably related to the corresponding envelopes.

The left side flank preferably comprises at least two surfaces, wherein a first surface adjoins the main side and is in angular position towards a second surface. The left side flank preferably further comprises a third surface being in angular position towards the second surface. Preferably, the first and the second surface form a third angle of 140° to 175°, particularly preferably 160° to 170°. The second and the third surface preferably form a fourth angle of 100° to 150°, preferably 115° to 135°.

The first surface preferably is substantially planar and more preferably comprises the attachment means. In the present case, substantially planar is to be understood that the surface is shaped such that it would fit between two parallel planes having a distance of 2 mm, preferably 1 mm to each other.

The right side flank preferably comprises at least a fourth and a fifth surface. The fourth surface preferably adjoins the main side and is in angular position towards the fifth. Preferably, the fourth surface is convexly shaped and adapted to cling to a planar surface. It is preferred that the edge of the fourth surface in cross section has a length of 1 mm to 20 mm, more preferably 1 mm to 10 mm, particularly preferably 1.5 mm to 6 mm. Additionally or alternatively it is preferred that the total length of the right side flank's edge in cross-section is at least twice as long, more preferably three to four times as long as the edge of the fourth surface's cross section. Preferably, the fourth and the fifth surface (the two surfaces of the right side flank) form a fifth angle of 115° to 170°, particularly preferably 135° to 150°. These preferred shapes of the side flanks are advantageous for an ideal fit into a joint which is inbetween a sanitary object and a wall.

Preferably, the left and the right side flank are not symmetrical. It is further preferred, that the above defined second angle is smaller than the first angle. Hence, two sealing lips with different material thicknesses are created, one of which can be advantageously applied to the sanitary object, the other to an angular oriented surface, e.g. a tiled wall. The asymmetrical shape preferably improves fitting of the joint tape on concavely shaped surfaces of sanitary objects since the joint tape can be deformed, adjusted and pressed into shape such that it smoothly clings to the adjacent surfaces during installation. Moreover, the joint tape's geometry preferably improves the ability to fit the joint tape around radii or in corners.

It is further preferred that at least one surface of the left side flank and at least one surface of the right side flank adjoin each other, preferably with a sixth angle of 25° to 45°, forming a tip which preferably is slightly tilted towards one side flank, particularly preferably towards the left side flank. Alternatively, the left and right side flanks may not adjoin each other directly but may adjoin a further tip surface which connects both side flanks.

Preferably, a ratio of a width defined in a direction perpendicular to the longitudinal direction (cross-sectional width) and a height defined in a direction perpendicular to both, the longitudinal direction and the direction of the width (cross-sectional height), is between 0.3 and 0.8, preferably between 0.4 and 0.6. Preferably, the height is the distance from the tip or edge of the tip surface to a middle portion, preferably the middle point, of the edge of the main side in cross-section. Such a width-to-height-ratio of the joint tape is preferred since it fits to commonly sized joints in sanitary applications. Preferably, the joint tape is suitable to be applied to joints having a small width. In the context of the present description, a small width is to be understood as a width of less than 5 mm, more preferably less than 4 mm, more preferably less than 3 mm, more preferably less than 2 mm, more preferably 1 mm or less. The joint tape preferably is applicable at any joints having a width of 1 mm to 20 mm, more preferably 1 mm to 10 mm.

It is preferred that the joint tape is made of homogeneous material. Preferably, the joint tape comprises at least one of the following materials: silicone rubber, acrylic rubber, nitrile rubber. If any type of rubber is comprised in the joint tape, the rubber percentage preferably is at least 35%, particularly preferably at least 50%. Of course, the joint tape can also be made of inhomogeneous material or can comprise any other material which has at least minimal elastic properties as e.g. polymers, in particular organic silicone substitutes, foam material or thermoplastic urethanes (TPU).

Furthermore, it is preferred that the joint tape comprises a material with a Young's modulus under standard conditions between 0.01 N/mm² and 30 N/mm², more preferably between 0.5 N/mm² and 30 N/mm² or between 0.1 N/mm² and 10 N/mm², particularly preferably of 1 N/mm² to 10 N/mm². Preferably, the joint tape comprises a tensile strength of at least 5 N/mm² and an elongation of break in the area of 100% to 1000%. The materials Young's modulus, tensile strength and elongation of break are determined under standard conditions by using a tensile test with a deformation rate of 50 mm/min.

It is preferred that the joint tape can be deformed, e.g. extended, comfortably by usual manual force. This property can be determined with a test stand comprising two round pins with a diameter of 50 mm, which are stiff in relation to the test material. One pin is fixed, the other pin is equipped with a load cell and arranged to move on an axis in such a way that the distance between the two pins can be adjusted as required. First, a test specimen (an elongated joint tape formed into a ring-shape by connecting its two ends) is placed around the two pins in completely unloaded condition. Then, the distance between the pins is increased until a force of 1 N is applied to the movable pin. The distance between the two pins in this position is defined as the initial length of the test specimen. Now, the distance between the two pins is increased until a force of 50 N is applied to the movable pin. The distance between the two pins in this position is defined as the extended length of the test specimen. Thus, the quotient of the extended length to the initial length describes, how far the test specimen is extendable with the applied force. In the current invention it is preferred that the joint tape is extendable to at least 105%, preferably to at least 110%, preferably to at least 120%, preferably to at least 130%, preferably to at least 140%, preferably to at least 150%, particularly preferably to at least 160% when applying a force of 50 N.

The above described properties preferably are in particular advantageous to install the joint tape by deforming it and pressing it at least partly into a joint, preferably at standard-sized sanitary objects, preferably without using tools. It is preferred to offer the joint tape with the main body colored in one of the following colors: white, black, grey and/or further colors that fit to available colors of tiles and/or sanitary objects, in particular earthly colors or anthracite. The attachment means may have the same color or may be transparent. Nevertheless, it is possible as well to produce the joint tape or the joint tape's main body in any other color.

The joint tape preferably comprises two end faces, wherein the side flanks and the main side extend between these two end faces along the longitudinal direction. A length of the joint tape preferably is defined by the distance of the two end faces. Preferably, the two end faces are distant from each other in an uninstalled condition.

The attachment means preferably is suitable to adhere to or to show good adhering performance for or applicability on at least one of the following materials: rubber, porcelain, ceramics, sanitary ware, wood, tiles, concrete, screed, natural stone, PVC or lime plaster. Preferably, the attachment means is any one of an adhesive tape, silicone, a thermal adhesive, a patching cement or any other chemical adhesive. Particularly preferably, the attachment means may be a double-sided adhesive mounting tape. The attachment means preferably may comprise a polyester duct tape and/or acrylic adhesives. The attachment means preferably has a thickness smaller than 2 mm, more preferably smaller than 1 mm, more preferably of 0.05 mm to 0.5 mm. The attachment means preferably may have an elongation at break of 40% to 60% and/or a tensile strength of 15 N/cm to 30 N/cm. Preferably, the attachment means may have a temperature resistance of at least −30° C. to 60° C., more preferably −40° C. to 100° C. The attachment means may preferably show at least one of the following: good ageing resistance (UV), good chemical and/or humidity resistance, good applicability on glass, ceramics and/or rubber, good standard shear resistance under standard conditions and an adhesion to PS, PC, PET or ABS of at least 4 N/cm, more preferably at least 8 N/cm (preferably according to a quality classification and/or under standard test conditions of tesa SE, located in 22848 Norderstedt, Germany). Additionally or alternatively, it is preferred that the adhesive force of the attachment means is, as expressed by 180° peel force, at least 0.5 N/25 mm, preferably at least 1 N/25 mm, preferably at least 2 N/25 mm, measured at a 25 mm wide and 150 mm long section of an attachment means that got installed 24 hours in advance at a temperature of 20° C. It is preferred to use tesafix® 4965 offered by tesa SE, DuploCOLL® 377 offered by Lohmann GmbH & Co. KG, located in 56567 Neuwied, Germany or any similar adhesive material as an attachment means. The attachment means thus can ensure a proper installation, preferably a proper adhesion, of the joint tape to a surface of a sanitary object.

Preferably, the attachment means is provided to one of the side flanks. More preferably, the attachment means is provided to one of the side flanks along at least 50%, preferably at least 80% of the length of the elongated joint tape and/or along at least 30 cm, preferably 60 cm and particularly preferably 100 cm. Preferably, the attachment means may at least be provided to a middle section of the elongated joint tape, preferably wherein the middle section is defined as an area around a point indicating half the distance between the two end faces. The attachment means preferably may be provided to only one or two surface(s) of one side flank, preferably to the first or to the first and second surface(s) of the left side flank. Alternatively, the first, second and/or third surface of the left side flank preferably may be provided with an attachment means. Additionally, it alternatively may be preferred to provide both of the side flanks, i.e., the left and the right side flank, with an attachment means. In cross section, the attachment means preferably may cover almost the entire edge of the respective surface or may only partly cover the respective surface, e.g. only 50%. It is preferred that the attachment means in cross section covers at least 20%, more preferably at least 30%, more preferably at least 50% and preferably not more than 90%, more preferably not more than 80% and more preferably not more than 60% of the respective surface's edge. The attachment means may comprise only one coherent tape or two or more single tapes being arranged at distance to each other at the side flank. Preferably, the attachment means is distant from the main side and/or the main side does not interact with the attachment means. Preferably, the main side thus remains visible since it is not attached to a surface.

In one embodiment, the joint tape preferably may comprise a connection element adapted to connect both end faces of the joint tape. Preferably, the connection element is attached to one end face or around one end portion of the joint tape. The connection element preferably is a dimensionally stable component comprising preferably plastics or metal, particularly preferably stainless steel. An inner contour of the connection element preferably corresponds, at least partly, to an outer contour of the joint tape. It is preferred that the connection element has a length of at least 30 mm, preferably at least 50 mm, extending along the joint tape's longitudinal direction. The connection element preferably comprises at least two parts and/or at least one spike, preferably two spikes, particularly preferably eight spikes. Alternatively, the connection element may preferably be one of the following: silicone, an adhesive or shrinking tape.

An elongated joint tape equipped with such a connection element can be formed to a ring-like form by attaching both end faces to each other prior to installation. Thus, the joint tape can be pulled over a wall-mounted or standalone sanitary object by elastic stretching and—due to its restoring forces—the joint tape may keep itself in the joint and cover the joint smoothly as described in the DE Patent Application DE 22 157 396.7. While it is possible to additionally attach the joint tape to a surface of the sanitary object with the attachment means, this preferably may not necessarily be essential. Attaching both end faces of the joint tape by using the connection element, a ring-shaped joint tape similar to the one disclosed in DE 22 157 396.7, which hereby is incorporated herein by reference, is built.

It is preferred, that the described joint tapes are adapted to be reusable and are preferably used to cover a joint which is located between two or three adjacent surfaces which are in angular position towards each other, particularly preferably a joint between a wall and a, e.g. wall-mounted, sanitary object or a joint between two walls being at an angle to each other and a surface of a sanitary object. Preferably, the term reusable in the present disclosure relates only to the joint tape's main body and excludes the attachment means. As it is apparent to the skilled reader, it might be necessary to renew or exchange the attachment means as soon as it was used once. However, preferably, it is possible to reuse the entire joint tape and—if necessary—only add new attachment means. In any way, it is preferred that installation can be performed without using any tools.

The installed joint tape preferably clings to at least one of the adjacent surfaces, the side flanks of the joint tape are preferably deformed in installed condition and the tip or tip surface preferably is in the joint. In other words, it is preferred that at least one side flank and/or the main side are deformed in installed condition and the joint tape's main body at least partly is in the joint. Preferably, the rather tiny tip is pressed in the joint, even if it is a joint having a small width. This preferably is possible due to high snugness and/or elasticity of the joint tape, preferably even if the joint tape is made of homogenous material. The expression “in the joint” preferably means that at least one point of the joint tape is more distant from the main side than a fictive connection line or point of the two or three adjacent surfaces. In other words, fictive extensions of the surfaces adjacent to the joint which meet each other forming the connection line or point would preferably intersect the joint tape which is installed in the joint.

The present invention further relates to a method for covering a joint between two or three angled surfaces, the joint having a length, the method comprising the following steps:
(a) Providing an elongated joint tape;
(b) Adhering the joint tape to one of the surfaces adjacent to the joint by using an attachment means;
(c) Pressing the joint tape at least partly into the joint, preferably such that the joint tape clings to the adjacent surfaces.

Method step (b) preferably includes deforming the joint tape by adhering it to the surface, preferably such that the size of the third angle changes, particularly preferably such that the joint tape is at least partly in sealing contact with the surface. Preferably, method step (b) further includes adhering the joint tape to a sanitary object, preferably to a wall-mounted or stand-alone sanitary object, preferably wherein the joint passes around such a sanitary object.

The method preferably further comprises the following steps if the joint is passing around a sanitary object (then, the length of the joint is the joint's circumference):
(d) Sealing a gap between two end faces of the elongated joint tape.

In this case, preferably, method step (d) is performed after method step (b). The sealing in method step (d) preferably is performed by using silicone, an adhesive or the connection element.

Preferably, the method further comprises the following step:
(e) Cutting the elongated joint tape to a specific length which is associated with the length of the joint.

Method step (e) preferably includes cutting the joint tape to a length which is between 70% and 110%, preferably between 95% and 101% of the joint's length.

The method preferably is performed at a joint comprising a curvature, a radius or an angle. The joint tape, after installation, preferably clings to at least one of the adjacent surfaces. The method steps preferably are performed without using any tools other than a knife or scissors.

Preferably, the method further comprises at least one of the following steps:
(f) Removing the joint tape, preferably without any tools;
(g) Reusing a joint tape, preferably the removed joint tape, for covering the same or another joint.

Removing and reusing of the joint tape primarily relates to the joint tape's main body. The attachment means might not be completely removable without using mechanic or chemical tools or substances. Since the attachment means might lose adhesive force once it was installed and subsequently removed, it might be necessary to add new attachment means when reusing the joint tape.

The present invention also relates to the following aspects:
1. Elongated joint tape for covering a joint, the joint tape having a main body extending in a longitudinal direction, being enclosed by one convexly shaped main side, one concavely shaped right side flank and one concavely shaped left side flank, wherein the joint tape comprises elastic material, wherein the joint tape is asymmetrically tapering along the side flanks in a direction perpendicular to the longitudinal direction, and wherein one of the side flanks comprises an attachment means.
2. Joint tape according to aspect 1, wherein the main side remains visible once the joint tape is installed.
3. Joint tape according to any of aspects 1 or 2, wherein the left side flank adjoins the main side with a first inner angle of 15° to 60°, preferably 25° to 40° and/or wherein the right side flank adjoins the main side with a second inner angle of 5° to 55°, preferably 20° to 40°.
4. Joint tape according to aspect 3, wherein the first and second angles differ from each other, preferably wherein the second angle is smaller than the first angle.
5. Joint tape according to any of the preceding aspects, wherein the left side flank comprises at least two surfaces, wherein a first surface adjoins the main side and is in angular position towards a second surface, preferably, wherein the left side flank further comprises a third surface being in angular position towards the second surface.
6. Joint tape according to aspect 5, wherein the first surface comprises the attachment means, preferably wherein the first surface is substantially planar.
7. Joint tape according to any of aspects 5 or 6, wherein the first and the second surface form a third angle of 140° to 175°, preferably 160° to 170°, particularly preferably wherein the second and the third surface form a fourth angle of 100° to 150°, preferably 115° to 135°.
8. Joint tape according to any of the preceding aspects, wherein the right side flank comprises at least two surfaces, wherein a fourth surface adjoins the main side and is in angular position towards a fifth surface, preferably wherein the fourth surface is convexly shaped and adapted to cling to a planar surface.
9. Joint tape according to aspect 8, wherein the fourth and the fifth surface form a fifth angle of 115° to 170°, preferably 135° to 150°.
10. Joint tape according to any of aspects 8 to 9, wherein the edge of the right side flank in cross-section is at least twice as long, preferably three to four times as long as the edge of the cross-section of the fourth surface.
11. Joint tape according to any of aspects 5 to 10, wherein the fourth surface in cross-section has a length of 1 mm to 20 mm, preferably 1 mm to 10 mm, particularly preferably 1.5 mm to 6 mm, and/or wherein the first surface in cross-section has a length of 5 mm to 60 mm, preferably 10 mm to 50 mm, particularly preferably 20 mm to 40 mm.
12. Joint tape according to any of the preceding aspects, wherein at least one surface of the left side flank and at least one surface of the right side flank adjoin each other forming a tip which is slightly tilted towards one side flank, preferably towards the left side flank.
13. Joint tape according to any of the preceding aspects, wherein the ratio of a width defined in a direction perpendicular to the longitudinal direction and a height defined in a direction perpendicular to both, the longitudinal direction and the direction of the width, is between 0.3 and 0.8, preferably between 0.4 and 0.6.
14. Joint tape according to aspects 12 and 13, wherein the height is the distance from the tip to a middle portion, preferably the middle point, of the edge of the main side in cross-section.
15. Joint tape according to any of the preceding aspects, wherein the joint tape is made of homogeneous material.
16. Joint tape according to any of the preceding aspects, comprising a material with a Young's modulus under standard conditions between 0.5 N/mm² and 30 N/mm², particularly preferably 1 N/mm² to 10 N/mm² and/or wherein the joint tape comprises at least one of the following materials: silicone rubber, acrylic rubber, nitrile rubber, betyl rubber, latex, thermoplastic polyurethane (TPU).
17. Joint tape according to aspect 16, wherein the rubber percentage is at least 35%, preferably at least 50%.
18. Joint tape according to any of the preceding aspects, wherein the joint tape is extendable to at least 110%, preferably to at least 130%, particularly preferably to at least 160% if a force of 50 N is applied.
19. Joint tape according to any of the preceding aspects, which is adapted to be reusable.
20. Joint tape according to any of the preceding aspects, wherein the joint tape comprises two end faces, wherein the side flanks and the main side extend between these two end faces along the longitudinal direction, preferably wherein a length of the joint tape is defined by the distance of the two end faces and/or wherein the two end faces are distant from each other in an uninstalled condition.
21. Joint tape according to any of the preceding aspects, wherein the attachment means is suitable to adhere to at least one of the following materials: porcelain, ceramics, sanitary ware, wood, tiles, concrete, screed, natural stone, PVC or lime plaster.
22. Joint tape according to any of the preceding aspects, wherein the attachment means is any one of an adhesive tape, silicone, a thermal adhesive, a patching cement or any other chemical adhesive.
23. Joint tape according to any of the preceding aspects, wherein the attachment means is provided to one of the side flanks along at least 50%, preferably at least 80% of a length of the elongated joint tape and/or wherein the attachment means is provided to one of the side flanks along at least 10 cm, preferably 60 cm and particularly preferably 100 cm.
24. Joint tape according to any of the preceding aspects, wherein the attachment means is distant from the main side and/or wherein the main side does not interact with the attachment means.
25. Joint tape according to any of the preceding aspects, wherein the adhesive force of the attachment means is, as expressed by 180° peel force, at least 0.5 N/25 mm, preferably at least 1 N/25 mm, measured at a 25 mm wide and 150 mm long section of an attachment means that got installed 24 hours in advance at a temperature of 20° C.
26. Joint tape according to any of the preceding aspects, wherein the joint tape comprises a connection element adapted to connect both end faces of the joint tape, preferably wherein the connection element is attached to one end face or around one end portion of the joint tape.
27. Joint tape according to aspect 26, wherein the connection element is one of the following: silicone, an adhesive, shrinking tape or a dimensionally stable component.
28. Joint tape according to any of aspects 26 or 27, wherein the connection element is a dimensionally stable component comprising plastics or metal, preferably stainless steel.
29. Joint tape according to aspect 28, wherein an inner contour of the connection element at least partly corresponds to an outer contour of the joint tape and/or wherein the connection element has a length of at least 30 mm, preferably at least 50 mm, extending along the joint tape's longitudinal direction.
30. Joint tape according to any of aspects 28 or 29, wherein the connection element comprises at least two parts and/or wherein the connection element comprises at least one spike, preferably two spikes, particularly preferably eight spikes.
31. Method for covering a joint between two angled surfaces, the joint having a length, the method comprising the following steps:
   (a) Providing an elongated joint tape according to any of the preceding aspects;
   (b) Adhering the joint tape to one of the surfaces adjacent to the joint by using the attachment means;
   (c) Pressing the joint tape at least partly into the joint.
32. Method according to aspect 31, wherein the joint is passing around a sanitary object, the length of the joint being the joint's circumference, the method further comprising the following step:
   (d) Sealing a gap between two end faces of the elongated joint tape.
33. Method according to aspect 32, wherein step (d) is performed after step (b), preferably wherein the sealing in step (d) is performed using silicone, an adhesive or the connection element.
34. Method according to any of aspects 31 to 33 further comprising the following step:
   (e) Cutting the elongated joint tape to a specific length which is associated with the length of the joint.
35. Method according to aspect 34, wherein step (e) includes cutting the joint tape to a length which is between 70% and 110%, preferably between 95% and 101% of the joint's length.
36. Method according to any of aspects 31 to 35, wherein step (b) or (c) includes deforming the joint tape, preferably such that the size of the third angle changes, particularly preferably such that the joint tape is at least partly in sealing contact with the surface.
37. Method according to any of aspects 31 to 36, wherein step (b) includes adhering the joint tape to a sanitary object, preferably to a wall-mounted or stand-alone sanitary object, preferably wherein the joint passes around such a sanitary object.
38. Method according to any of aspects 31 to 37, wherein the joint comprises a curvature, a radius or an angle.
39. Method according to any of aspects 31 to 38, wherein the joint tape, after installing, clings to at least one of the adjacent surfaces.
40. Method according to any of aspects 31 to 39, wherein the method steps are performed without using any tools other than a knife or scissors.
41. Method according to any of aspects 31 to 340 further comprising the step:
   (f) Removing the joint tape or its main body, preferably without any tools.
42. Method according to aspect 41 further comprising the step:
   (g) Reusing the removed joint tape for covering the same or another joint.
The present summary is provided only by way of example and not limitation. Other aspects of the present invention will be appreciated in view of the entirety of the present disclosure, including the entire text, claims, and accompanying figures.

### BRIEF DESCRIPTION OF THE DRAWINGS

In the following, preferred embodiments of the invention are described by way of example with reference to the following figures, which show:

FIG. 1 a schematic 3D-view of a section of an elongated joint tape according to a preferred embodiment;

FIG. 2 a cross-section of the joint tape from FIG. 1;

FIG. 3 a cross-section of an elongated joint tape in an alternative embodiment;

FIG. 4 a cross-section of an elongated joint tape in another alternative embodiment;

FIG. 5 a cross-section of an elongated joint tape in still another alternative embodiment;

FIG. 6 a 3D-view of a connection element according to a preferred embodiment;

FIG. 7 a cross-section of the connection element from FIG. 6;

FIG. 8 a 3D-view of an elongated joint tape according to a preferred embodiment installed to a wall-mounted sanitary object;

FIG. 9 a perspective cross section through joint tape, wall and sanitary object from FIG. 8 during installation;

FIG. 10 the perspective view of FIG. 9 complemented with virtual planes; and

FIG. 11 a perspective cross section through joint tape, wall and another sanitary object.

While the above-identified figures set forth one or more embodiments of the present invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and embodiments of the present invention may include features, steps, and/or components not specifically shown in the drawings.

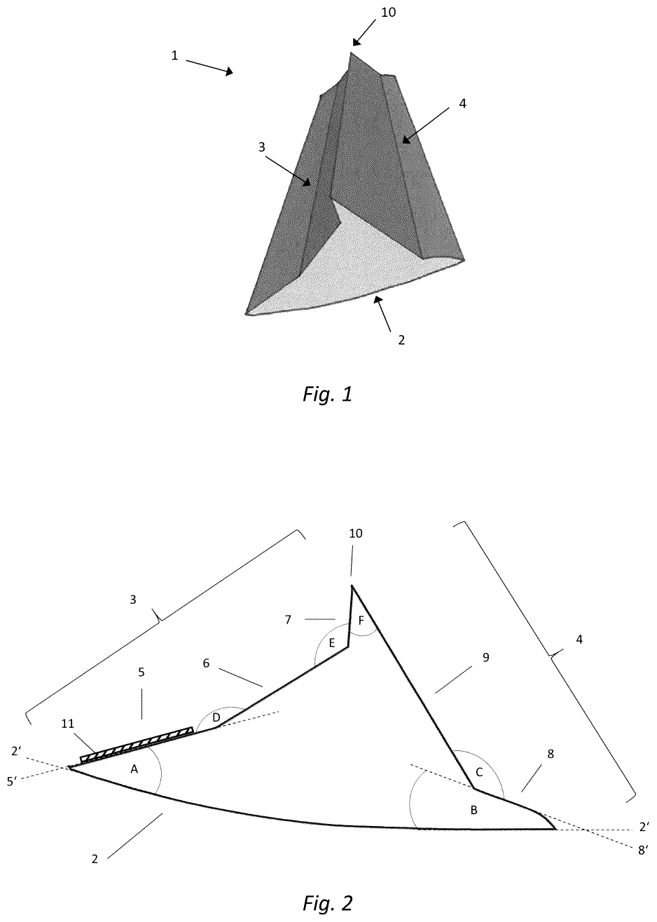

DETAILED DESCRIPTION OF ILLUSTRATIVE EMBODIMENTS FIG. 1 schematically illustrates a 3D section of a joint tape 1 according to a preferred embodiment. The embodiment shown comprises a main side 2, a left side flank 3 and a right side flank 4. As it will be apparent to the skilled person, left and right side could also be exchanged depending on the orientation of the cross-section. Further, an asymmetrical tapering of the two side flanks is visible. In this embodiment, both side flanks are adjoining each other forming a tip (or tip edge) 10 which is slightly tilted towards the left side flank. As it is shown in FIG. 1, the cross section is invariable over the entire length of the joint tape.

In FIG. 2, a cross-section of the joint tape from FIG. 1 is shown. In this embodiment, the contour of the main side 2 is convexly shaped whereas both contours of the left side flank 3 and of the right side flank 4 are concavely shaped. The left side flank 3 of the shown embodiment comprises three surfaces. One first surface 5 adjoins the main side 2 with an inner angle A, a third surface 7 adjoins the right side flank with an inner angle F and a second surface 6 is located in between the two surfaces 5 and 7. The exterior angle between surface 5 and surface 6 is indicated with letter D. Surfaces 6 and 7 adjoin each other with an exterior angle E. In this embodiment, the right side flank 4 comprises two surfaces. A first surface 8 is convexly shaped, preferably to improve installation, adjoins the main side 2 with an inner angle B and is oriented to a second surface 9 in an exterior angle C. The second surface 9 of the right side flank adjoins the third surface 7 of the left side flank with the inner angle F. Hence a tip 10 is formed.

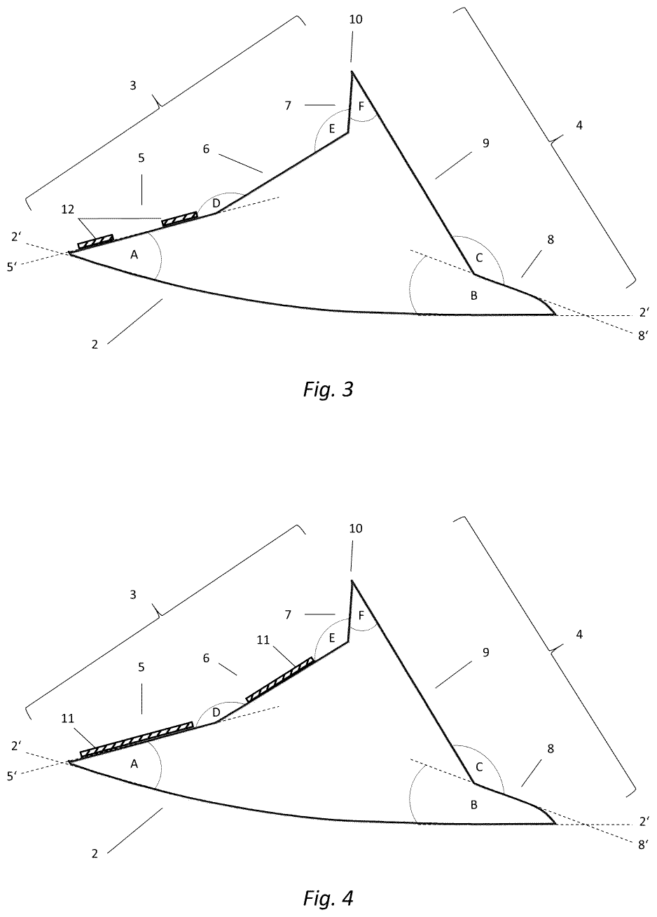

The first surface 5 of the left side flank 3 comprises the attachment means. In the present embodiment, the attachment means is an adhesive strip 11 covering approximately 75% of the first surface's edge in cross section. An alternatively preferred position and size of the attachment means is described below with reference to FIG. 3.

The overall shape of the various tip-shaped extensions in particular governs the functionality of the joint tape. This shape is connected to the corresponding angles but it is not always obvious how to determine the described angles since some angles are formed by curved contours. Thus, envelopes of these contours are created as indicated with 2′, 5′ and 8′. Creating these envelopes, the attachment means preferably remains unconsidered. The named angles are determined by measuring the angles between these envelopes. Achieving a suitable tip-shape on the left side, it is preferred to have an angle A between 25° and 40°. In the shown embodiment, this angle A is defined by a convexly shaped main side 2 and a plane surface 5 of the left side flank. In further possible embodiments, this angle A may be formed by differently shaped surfaces, such as e.g. a left side flank 3 comprising only one, preferably concavely shaped, surface. Furthermore, embodiments are possible in which the left side flank comprises only two or even more than three surfaces which may be plane or curved while one surface adjoins the main side with the named angle A and another surface forms the angle F together with the right side flank. While the right side flank 4 comprises two surfaces in the shown embodiment including one convexly shaped surface 8, this right side flank 4 may be designed to comprise only one surface, preferably concavely shaped, or even more than two plane or curved surfaces, in other embodiments. Nevertheless, it is preferred that angle F is between 25° and 45° to achieve a suitable tip-shaped extension in the upper area of the shown cross section. The right side flank 4 further forms a tip-shaped extension on the right side by enclosing angle B together with the main side 2. Thus, angle B is preferred to be between 20° and 40°.

The described shape of the joint tape is in particular advantageous to cover a joint passing along a convexly shaped surface of a sanitary object. The ingenious shape of the joint tape is further beneficial to cover joints which are non-linear, i.e., comprise curvatures or radii. Due to the joint tape's shape and elasticity, the joint tape can perfectly cling to adjacent surfaces. In particular due to the, preferably rather tiny, tip 10, which geometry is prescribed by forming the joint tape with the preferred angle sizes, and due to the elastic material used, it is possible to press the joint tape at least partly in the joint by manpower only. It is preferred that the joint tape can be pressed at least partly in the joint such that the main side 2 transforms from a convex surface (in uninstalled condition) into a concave surface or a surface having at least one, preferably two concave sections (in installed condition). Thus, the joint tape 1 fits neatly to the joint and the main side 2 is optically pleasant and easy to clean. Moreover, transformation of the main side's shape together with the joint tape's elasticity may simplify installation. Preferably, the necessary installation force can be reduced due to a spring effect. The described behavior preferably applies as well for using the joint tape at a joint having a small width, e.g., a width between 1 mm and 10 mm or a width of 1 mm or smaller. Moreover, installation of the joint tape 1 in joints which are between angled surfaces being not perpendicular to each other is possible as well. The joint tape according to the described embodiment preferably is possible to fit in a joint between two surfaces having an angle of 45° to 120°, more preferably 60° to 110°, more preferably of 80° to 100°.

FIG. 3 shows a cross-section of a joint tape having the same geometry as described with reference to FIG. 2 but comprising an attachment means 12 in a different configuration. The attachment means 12 shown in FIG. 3 comprises two pieces of adhesive tape being attached to the first surface 5 of the left side flank 3 at distance to each other and running substantially parallel along the joint tape's length. As it is apparent from the figure, the attachment means 12 covers only around 30% to 50% of the first surface's edge in cross section. However, the adhesive force of the attachment means 12 is still sufficient to attach the joint tape to a surface of a sanitary object. This way, material can be saved. As it will be apparent to the skilled reader, the thicknesses of the adhesive tapes 11, 12 are not shown to scale in the embodiments of FIGS. 2 and 3.

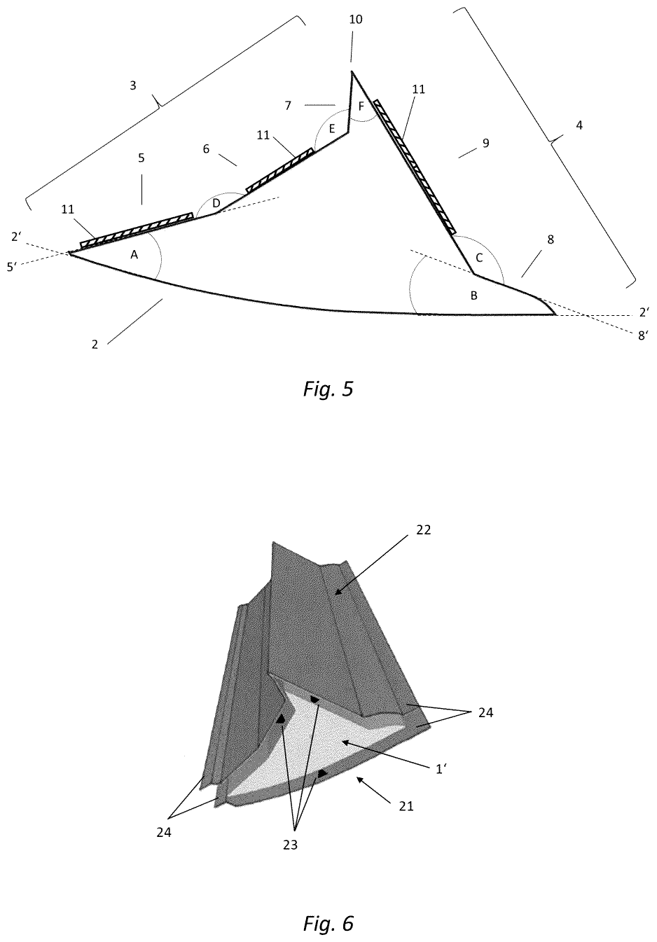

FIGS. 4 and 5 show further examples of joint tapes having an attachment means in form of adhesive strips 11. In FIG. 4, the joint tape 1 comprises as an attachment means an adhesive strip 11 at the first surface 5 and another adhesive strip 11 at the second surface 6 of the left side flank. While in the shown embodiment, the third surface 7 of the left side flank lacks an attachment means, there can be provided an attachment means to the third surface 7 in alternative embodiments as well. FIG. 5 shows a joint tape having an adhesive strip 11 provided to the right side flank. While the attachment means in the shown embodiment is provided to the second surface 9 of the right side flank it can alternatively or additionally be provided to the first surface 8 of the right side flank in alternative embodiments. In the embodiment shown in FIG. 5, the left side flank comprises an attachment means as well. However, this preferably is not essential. The attachment means in FIGS. 5 and 6 is shown as adhesive strips 11, but—as it will be apparent to the skilled reader—the attachment means may have any other configuration, e.g., the configuration of attachment means 12, as shown in FIG. 3.

The elongated joint tape 1 preferably has two end faces which are distant from each other ex factory. When installing the joint tape 1 around a wall-mounted or standalone sanitary object, the two end faces meet each other after installation. The elongated joint tape—when configured to cover a joint passing entirely around an object—may lack the attachment means 11, 12 at its end section. In other words, there might be a variant of the elongated joint tape where the attachment means is only present in a middle section of the joint tape's length and the end sections, e.g. the first and last 10 mm to 80 mm, preferably at least the first and last 50 mm, more preferably at least the first and last 60 mm, do not comprise any attachment means 11, 12 but preferably are configured to be connected with a connection element. However, the connection element preferably may work as well with joint tapes having the attachment means arranged along their entire length. For connecting the two end faces or end sections to each other, an adhesive or a dimensionally stable connection element can be used. Preferably, it is possible as well, to use the connection element already prior to installation to connect the two end faces of the elongated joint tape thus building a ring-shaped joint tape which can be slipped over a wall-mounted or standalone sanitary object by elastic stretching.

One preferred embodiment of a connection element is shown in FIG. 6 in relation to a section of the elongated joint tape 1. The connection element in the shown embodiment is a connection clip 20 comprising two parts, a cavity 22 and a cover 21. Both parts are equipped with spikes 23 on their inner sides and comprise flange surfaces 24. The connection clip preferably has a length of 30 mm to 50 mm (defined in the joint tapes longitudinal direction). In the shown embodiment, the connection clip 20 is mainly made of stainless steel. First, sheet metal is used to produce the shape by metal forming. Subsequently, the spikes are fixed.

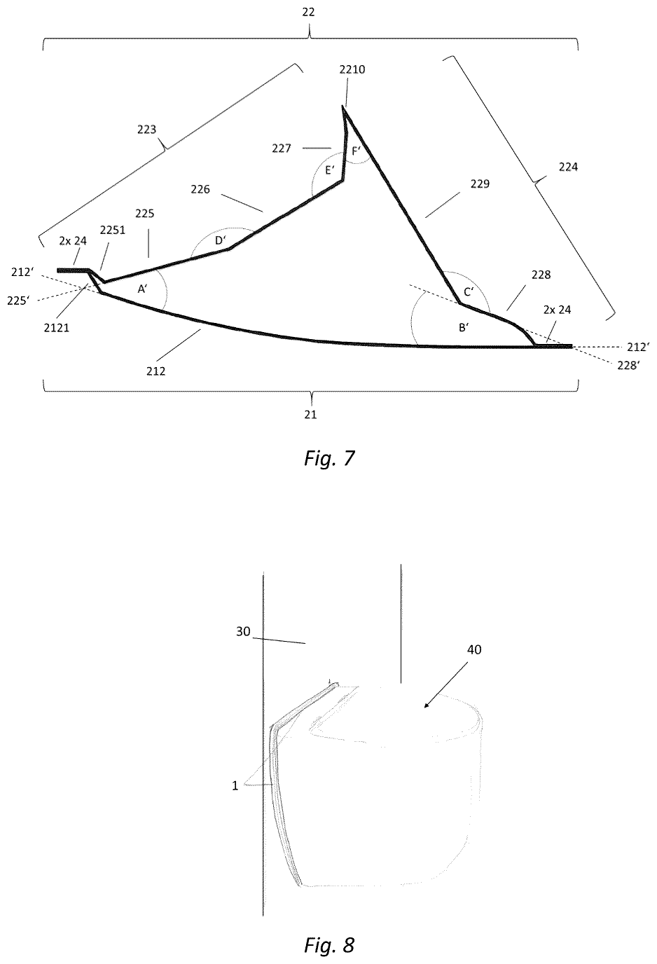

The cross-section of the connection clip 20 is displayed in FIG. 7. Therein, the connection clip is shown in closed condition. The contour of cover 21 corresponds to the contour of the joint tape's main side 2 (see FIG. 2) and comprises three surfaces: one convexly shaped main surface 212 comprising one flange area 24 on its right side, one connection surface 2121 adjoining the main surface on its left side and connecting it to the third surface which is a further flange surface 24. The cavity 22 comprises a left side flank 223 and a right side flank 224 which correspond to the side flanks 3 and 4 of the joint tape from FIG. 2. While the cavity's right side flank 224 basically comprises two surfaces 229 and 228 and only one additional flange surface 24, the cavity's left side flank comprises, besides the three surfaces 225-227 known from the joint tape's geometry, two further surfaces: connection surface 2251 and a further flange surface 24. In this embodiment, the displayed angles A′ to F′ correspond to angles A to F from FIG. 2, so the drawn in angle A′ ignores the connection surfaces 2121 and 2251. Angle A′ is measured between the envelopes 225′, 212′ of surfaces 225 and 212 to indicate the analogy to angle A from FIG. 2. Nevertheless, due to the two connection surfaces 2121 and 2251, the connection clip in the shown cross-section encloses an area which is slightly bigger than the cross-section of the compressed joint tape. Hence, closing a joint tape with such a connection clip, deformed material can enter the additional cavity built from the connection surfaces 2121 and 2251. Therefore, all flange surfaces 24 can be in direct contact with each other. Thus, no material is trapped between the flanges and so, the connection clip can be closed completely using any kind of well-known connection elements such as clamps, screws, rivets or adhesives.

FIG. 8 shows an installed joint tape 1. In this example, the joint tape 1 covers a joint between a wall 30 and a wall-mounted sanitary object 40. So, the joint passes around the sanitary object 40. The elongated joint tape therefore, in installed condition, preferably becomes ring-shaped. In installed condition—as shown in FIG. 8—it is not apparent whether the elongated joint tape has been formed to its ring shape prior to or during its installation. However, the joint tape 1 fits smoothly around the sanitary object 40, in particular also in areas where the sanitary object 40 is non-linear and comprises radii. However, installing a joint tape to a straight or linear joint (only along one straight edge) may be possible as well, at least in the function of an easy installable cover or splash guard.

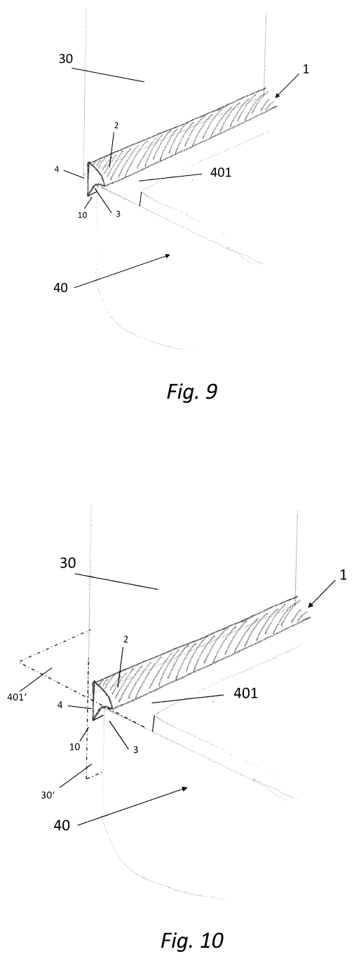

In FIG. 9, a cross-section of the installation example from FIG. 8 is displayed in a state during installation. The joint between the wall 30 and the wall-mounted sanitary object 40 is covered by a joint tape 1 which cling to the substantially planar surface 30 and the surface 401, which preferably is convexly shaped, adjacent to the joint. The joint tape 1 is attached, e.g. adhered, to the surface 401 of the sanitary object 40 with its first surface 5 of the left side flank 3 by using the attachment means 11, 12. Once the joint tape 1 is attached to the surface 401 or by adhering the joint tape 1 to the surface 401, the joint tape can be pressed into the joint. This preferably can simply be done with the human hand or finger. By pressing the joint tape 1 into the joint, the joint tape 1 deforms and at least the first surface 8 of the joint tape's right sight flank 4 clings to the surface 30. Moreover, by pressing the joint tape 1 into the joint, the main side 2 gets deformed and preferably transforms into a concave shape. The tip or tip edge 10 of the joint tape 1 then—in installed condition—is in the joint, as it is apparent with reference to FIG. 10.

In a preferred embodiment, the end faces of the elongated joint tape meet each other as soon as the joint tape is attached entirely around the sanitary object 40. The end faces then, subsequently, can be connected to each other by using the connection element or simply some adhesive or silicone. Preferably, a sealed connection can be realized between the end faces and the adjacent surfaces. Alternatively, the two end faces of the elongated joint tape 1 can be connected to each other prior to installation. In this case, it is preferred that the joint tape having the ring shape prior to installation comprises a circumference which is smaller than the joint's circumference. So, the joint tape can be passed over the sanitary object and installed to the joint by elastic stretching. It is preferred hat the joint tape in this case is flipped inside out, so the main side faces to the center of the ring. Then, the joint tape is passed over the sanitary object until it is adjacent to the joint. Subsequently, the joint tape is flipped again, such that the attachment means 11, 12 sticks to the surface 401 of the sanitary object and the tip or tip edge 10 flips into the joint. The joint tape is then—in installed condition—in an elastically stretched state (the joint tape's circumference is bigger than it was before installation). Due to this elastic stretching, tensile forces act in the joint tape trying to compress it. Caused by the joint tape's ring-shape, these tensile forces act towards the center of the circumferential joint and pull the edge 10 into the joint, as it is illustrated in the figure. As the joint tape's width is larger than the joint's width, the joint tape 1 gets pressed to the adjacent surfaces 30 and 401. The joint tape's elasticity in combination with the tensile effect causes a deformation of the side flanks 3, 4. Preferably as it is the case when installing the elongated joint tape 1 without connecting the end faces, the deformation along with the asymmetrically tapering of the joint tape enables a precise fit, increases the pressing effect of the joint tape to the adjacent surfaces and ensures the joint tape clings neatly to the adjacent surfaces. Hence, the contours of at least one of the side flanks 3 and 4 are reshaped in installed condition, so the left side flank 3 clings at least partly to the sanitary object 40 while the right side flank 4 is in contact with the wall 30 and appears almost straight in the installation example. The edge of tip 10 is oriented to the joints center or bottom while the joint tape's main side 2 is the side visible to the user and adapted to ensure a neat look, long durability and easy cleaning of the covered joint. These advantages preferably are caused i.a. by the inventive shape of the joint tape and can also be achieved by attaching the joint tape at first to the joint, secondly pressing it with the fingers into the joint and subsequently connecting the end faces to each other or to an adjacent wall, floor or object before finishing the joint with a final action of pressing and smoothening the joint tape by hand (as described above).

FIG. 10 basically is a repetition of FIG. 9 but obviously indicating the joint tape's location in the joint. Thus, the expression “in the joint” can vividly be explained. The joint is formed between the adjacent surfaces 401 and 30. In this illustration, planes 401′ and 30′ are shown which can be seen as virtual extensions of surfaces 401 and 30, respectively. As it is apparent, a part of the joint tape 1 is on the other side of at least one of the planes 30′ and 401′ as the main side 2 of the joint tape. The joint tape thus is at least partly in the joint. In other words, the term “in the joint” can be defined as at least one point of the joint tape (here, e.g. the tip 10) being farther away from the main side 2 as the connection line between the two planes 401′ and 30′ (virtual extensions of surfaces 401 and 30, respectively). In case of two walls being adjacent to a sanitary object (three adjacent walls) the connection line apparently is a connection point. However, the above definition preferably remains applicable.

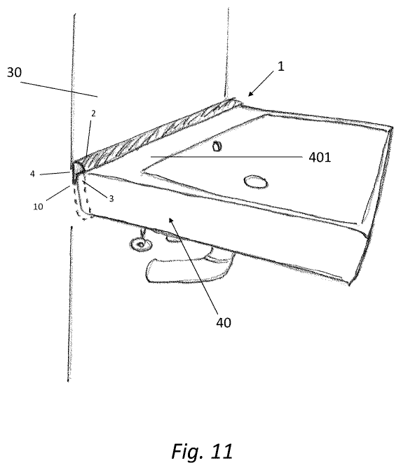

In FIG. 11, a cross section of an elongated joint tape 1 which got installed to another sanitary object 40—a washbasin. As it is apparent, the joint between the adjacent surfaces 30 of the wall and 401 of the washbasin is substantial rectangular in shape. So, the joint is non-linear comprising at least four curvatures at the corners of the rectangular shape. Moreover, the surface 401 of a washbasin in general is convexly shaped. However, the elongated joint tape 1 fits smoothly to the joint with the tip edge 10 being in the joint and side flanks 3 and 4 clinging to the surfaces. Left side flank 3 is adhered to the washbasin's surface 401 by the attachment means, preferably to provide proper positioning and long-time adhesion of the joint tape. Main side 2 in the shown configuration is concavely shaped. However, it is preferred that the joint tape 1 can further be pressed into the joint so that the main side changes into a concave shape.

In any case, the inventive shape of the joint tape 1 allows the joint tape to at least partly be pressed into the joint and it can cling to a convex surface of e.g. a sanitary object. Moreover, due to its elasticity, the joint tape is capable of covering any joint between two adjacent surfaces, e.g. a surface of a sanitary object and a surface of a tiled wall, preferably being in any angle between 45° and 120°, preferably between 60° and 110° and more preferably between 80° and 100° to each other. The inventive shape in combination with the joint tapes elasticity further improves the joint tapes smooth fit at or around radii, at corners or curvatures of surfaces, e.g. sanitary objects or walls, and joints, respectively. In other words, application of the inventive joint tape is in particular beneficial at non-linear joints. Moreover, application at joints having a small width is enabled or simplified, preferably due to the rather tiny tip-shaped extension including tip edge 10 and due to the elastic material used which preferably gives the joint tape high snugness. Additionally, due to the possibility to produce the joint tape's main body from only one homogenous material, production may preferably be simple, cost-efficient and recyclability may be improved.

Although the present invention has been described with reference to preferred embodiments, workers skilled in the art will recognize that changes may be made in form and detail without departing from the spirit and scope of the invention.

1. An elongated joint tape for covering a joint, the joint tape having a main body extending in a longitudinal direction, being enclosed by one convexly shaped main side, one concavely shaped right side flank and one concavely shaped left side flank, wherein the joint tape comprises elastic material, wherein the joint tape is asymmetrically tapering along the side flanks in a direction perpendicular to the longitudinal direction, and wherein one of the side flanks comprises an attachment means.

2. The joint tape according to claim 1, wherein the main side remains visible once the joint tape is installed.

3. Joint tape according to claim 1, wherein the left side flank adjoins the main side with a first inner angle of 15° to 60°.

4. The joint tape according to claim 3, wherein the first and second angles differ from each other, and wherein the second angle is smaller than the first angle.

5. The joint tape according to claim 1, wherein the left side flank comprises at least two surfaces, wherein a first surface adjoins the main side and is in angular position towards a second surface.

6. The joint tape according to claim 5, wherein the first surface comprises the attachment means, preferably wherein the first surface is substantially planar.

7. The joint tape according to claim 1, wherein the right side flank comprises at least two surfaces, and wherein a fourth surface adjoins the main side and is in angular position towards a fifth surface.

8. The joint tape according to claim 1, wherein at least one surface of the left side flank and at least one surface of the right side flank adjoin each other forming a tip which is slightly tilted towards one side flank.

9. The joint tape according to claim 1, wherein a ratio of a width defined in a direction perpendicular to the longitudinal direction and a height defined in a direction perpendicular to both, the longitudinal direction and the direction of the width, is between 0.3 and 0.8.

10. The joint tape according to claim 1, wherein the joint tape is made of homogeneous material, and wherein the joint tape comprises at least one of the following materials: silicone rubber, acrylic rubber, nitrile rubber, betyl rubber, latex, thermoplastic polyurethane (TPU).

11. The joint tape according to claim 1, wherein the joint tape comprises two end faces, wherein the side flanks and the main side extend between these two end faces along the longitudinal direction, wherein a length of the joint tape is defined by a distance of the two end faces, and/or wherein the two end faces are distant from each other in an uninstalled condition.

12. The joint tape according to claim 1, wherein the attachment means is any one of an adhesive tape, silicone, a thermal adhesive, a patching cement, or any other chemical adhesive.

13. The joint tape according to claim 1, wherein the attachment means is provided to one of the side flanks along at least 50% of a length of the elongated joint tape, and wherein the attachment means is provided to one of the side flanks along at least 60 cm.

14. A method for covering a joint between two angled surfaces, the joint having a length, the method comprising the following steps:
(a) providing an elongated joint tape according to claim 1;
(b) adhering the joint tape to one of the surfaces adjacent to the joint by using the attachment means; and
pressing the joint tape at least partly into the joint.

15. The method according to claim 14, wherein the joint comprises a curvature, a radius or an angle; wherein step (b) includes adhering the joint tape to a surface of a sanitary object; and wherein step (b) or (c) includes deforming the joint tape.

16. The method according to claim 14, wherein the method steps are performed without using any tools other than a knife or scissors.

17. The method according to claim 14, further comprising at least one of the following steps:
(d) removing the joint tape or its main body, without any tools
(e) reusing the removed joint tape for covering the same or another joint.

18. The joint tape according to claim 1, wherein the right side flank adjoins the main side with a second inner angle of 5° to 55°.

19. The joint tape according to claim 7, wherein the fourth surface is convexly shaped and adapted to cling to a planar surface.

20. The joint tape according to claim 12, wherein the attachment means is distant from the main side, and wherein the main side does not interact with the attachment means.
